(19) United States
(12) Patent Application Publication
(10) Pub. No.: US 2022/0278427 A1
(43) Pub. Date: Sep. 1, 2022

(54) ELECTROCHEMICAL CELLS CONNECTED IN SERIES IN A SINGLE POUCH AND METHODS OF MAKING THE SAME

(71) Applicant: 24M Technologies, Inc., Cambridge, MA (US)

(72) Inventors: Ryan Michael LAWRENCE, Cambridge, MA (US); Naoki OTA, Lexington, MA (US)

(73) Assignee: 24M Technologies, Inc., Cambridge, MA (US)

(21) Appl. No.: 17/743,631

(22) Filed: May 13, 2022

Related U.S. Application Data
(63) Continuation of application No. PCT/US2020/061498, filed on Nov. 20, 2020.
(60) Provisional application No. 63/009,085, filed on Apr. 13, 2020.
(60) Provisional application No. 62/938,107, filed on Nov. 20, 2019.

(51) Int. Cl. H01M 50/51; H01M 50/536; H01M 50/211; H01M 50/553; H01M 50/30; H01M 50/46

(52) U.S. Cl. CPC H01M 50/51; H01M 50/536; H01M 50/211; H01M 50/553; H01M 50/30; H01M 50/46

(57) ABSTRACT

Embodiments described herein relate to systems and stacks of multiple electrochemical cells. An electrochemical cell stack includes a plurality of electrochemical cells connected in series in a single pouch. Each electrochemical cell of the plurality of electrochemical cells includes an anode disposed on an anode current collector, a cathode disposed on a cathode current collector, and a separator disposed between the anode and the cathode. The anode current collector includes an anode tab and the cathode current collector includes a cathode tab. In some embodiments, a first electrochemical cell of the plurality of electrochemical cells can be connected in series to a second electrochemical cell of the plurality of electrochemical cells by electronically coupling the cathode tab of the first electrochemical cell to the anode tab of the second electrochemical cell.

### CROSS-REFERENCE TO RELATED APPLICATIONS

This application claims the priority to and the benefit of U.S. Provisional Application No. 62/938,107, entitled “ELECTROCHEMICAL CELLS CONNECTED IN SERIES IN A SINGLE POUCH AND METHODS OF MAKING THE SAME” and filed on Nov. 20, 2019 and U.S. Provisional Application No. 63/009,085, entitled “ELECTROCHEMICAL CELLS CONNECTED IN SERIES IN A SINGLE POUCH AND METHODS OF MAKING THE SAME” and filed on Apr. 13, 2020, the disclosures of each of which are hereby incorporated by reference in their entirety.

### TECHNICAL FIELD

Embodiments described herein relate to electrochemical cells connected in series in a single pouch and methods of making the same.

### BACKGROUND

Embodiments described herein relate to electrochemical cells connected in series in a single pouch and methods of making the same. Electrochemical cells can often be connected in series in order to increase the total voltage of a system while keeping the capacity of the system constant. For example, two 9-volt batteries connected in series can create a system with a voltage drop of 18-volts but with the same capacity as a single 9-volt battery. In addition, a battery management system (BMS) can be employed to control the operation of a single electrochemical cell or a system of electrochemical cells. In some instances, a BMS can monitor an electrochemical cell's state of charge, protect the electrochemical cell from operating outside of its safe operating area, balance individual cell voltages, or generally monitor and report performance statistics of the cell.

### SUMMARY

Embodiments described herein relate to systems and stacks of multiple electrochemical cells. An electrochemical cell stack includes a plurality of electrochemical cells connected in series in a single pouch. Each electrochemical cell of the plurality of electrochemical cells includes an anode disposed on an anode current collector, a cathode disposed on a cathode current collector, and a separator disposed between the anode and the cathode. The anode current collector includes an anode tab and the cathode current collector includes a cathode tab. In some embodiments, the anode tab can be a weld tab. In some embodiments, the cathode tab can be a weld tab. In some embodiments, a first electrochemical cell of the plurality of electrochemical cells can be connected in series to a second electrochemical cell of the plurality of electrochemical cells by electronically coupling the cathode tab of the first electrochemical cell to the anode tab of the second electrochemical cell. In some embodiments, the second electrochemical cell can be connected in series to a third electrochemical cell by electronically coupling the cathode tab of the second electrochemical cell to the anode tab of the third electrochemical cell. In some embodiments, the third electrochemical cell can be connected in series to a fourth electrochemical cell by electronically coupling the cathode tab of the third electrochemical cell to the anode tab of the fourth electrochemical cell. In some embodiments, the anode tab and the cathode tab of each of the plurality of electrochemical cells can be trimmed, such that the tabs that are to be coupled to each other are in-line with each other and do not contact other tabs. In some embodiments, each of the plurality of electrochemical cells can be disposed in a single pouch.

In some embodiments, each electronic coupling between a cathode tab and an anode tab, as well as the anode tab of the first electrochemical cell and the cathode tab of the fourth electrochemical cell, can also be coupled to an extension tab that protrudes outside of the single pouch. In some embodiments, a total voltage drop across the plurality of electrochemical cells can be custom selected by connecting a first connector to a first extension tab and connecting a second connector to a second extension tab. In some embodiments, an electrochemical cell system can include a plurality of electrochemical cell stacks, each electrochemical cell stack including a plurality of electrochemical cells disposed within a single pouch. In some embodiments, the electrochemical cell system can include a BMS, configured to control charge and discharge within specified limits. In some embodiments, each pouch of the system of electrochemical cells can include a degassing tab, configured to release gas built up during cell formation.

### BRIEF DESCRIPTION OF THE DRAWINGS

FIG. 1 shows a multicell, according to an embodiment.

FIGS. 2A-2B show an individual electrochemical cell, according to an embodiment.

FIGS. 3A-3E show a plurality of electrochemical cells connected in series and disposed in a single pouch to form a multicell, according to an embodiment.

FIGS. 4A-4B show a multicell system, according to an embodiment.

FIGS. 5A-5B show a multicell system, according to an embodiment.

FIGS. 6A-6B show a multicell system, according to an embodiment.

FIGS. 7A-7B show a multicell system, according to an embodiment.

FIG. 8A-8C show a plurality of multicells connected to a single BMS, according to an embodiment.

FIG. 9A-9B show a plurality of multicells having degassing tabs connected to a single BMS, according to an embodiment.

### DETAILED DESCRIPTION

Embodiments described herein relate to electrochemical cells connected in series in a single pouch and methods of making the same. Benefits of having multiple cells connected in series within a single pouch include reduced packaging material requirements for a given system size. This can lead to a reduced cost and overall system mass. For example, a system with multiple cells connected in series in a single pouch can have less aluminized sealing film and fewer feedthrough tabs.

Additional benefits of connecting a plurality of electrochemical cells in series in a single pouch include variability of voltage and/or capacity. For example, by organizing a series of tabs to contact the plurality of electrochemical cells at various points in the series of electrochemical cells, an external circuit can be attached to any pair of tabs to effect a wide range of voltages. For example, four lithium iron phosphate (3.2 V) electrochemical cells can be connected in series in a circuit in a single pouch. A first tab can be installed to contact the circuit at a point on the circuit upstream from the first electrochemical cell, a second tab can be installed at a point on the circuit between the first electrochemical cell and the second electrochemical cell, a third tab can be installed at a point on the circuit between the second electrochemical cell and the third electrochemical cell, a fourth tab can be installed at a point on the circuit between the third electrochemical cell and the fourth electrochemical cell, and a fifth tab can be installed at a point on the circuit downstream from the fourth electrochemical cell. An external circuit can then be connected to any pair of tabs in accordance with a desired voltage. For example, the external circuit can be attached to the first tab and the third tab to create a circuit with a voltage of 6.4 V. The external circuit can be attached to the first tab and the fourth tab to create a circuit with a voltage of 9.6 V. The external circuit can be attached to the first tab and the fifth tab to create a circuit with a voltage of 12.8 V. Any other combinations of tab connections to the external circuit are also possible.

In some embodiments, the plurality of electrochemical cells connected in series in a single pouch (also referred to herein as a “multicell”) can be connected in series or in parallel to one or a plurality of additional multicells. For example, several multicells can be connected in parallel in a multicell system to retain the same voltage variability while increasing the electrochemical capacity of the multicell system, as compared to a single multicell. In some embodiments, several multicells can be connected in series in a multicell system to provide higher voltage capability and more voltage variability, as compared to a single multicell. In some embodiments, a plurality of multicells can be connected both in series and in parallel to increase the electrochemical capacity and provide higher voltage capability/variability, as compared to a single multicell.

In some embodiments, the electrochemical cells described herein can include a semi-solid cathode and/or a semi-solid anode. In some embodiments, the semi-solid electrodes described herein can be binderless and/or can use less binder than is typically used in conventional battery manufacturing. The semi-solid electrodes described herein can be formulated as a slurry such that the electrolyte is included in the slurry formulation. This is in contrast to conventional electrodes, for example calendered electrodes, where the electrolyte is generally added to the electrochemical cell once the electrochemical cell has been disposed in a container, for example, a pouch or a can.

In some embodiments, the electrode materials described herein can be a flowable semi-solid or condensed liquid composition. In some embodiments, a flowable semi-solid electrode can include a suspension of an electrochemically active material (anodic or cathodic particles or particulates), and optionally an electronically conductive material (e.g., carbon) in a non-aqueous liquid electrolyte. In some embodiments, the active electrode particles and conductive particles can be co-suspended in an electrolyte to produce a semi-solid electrode. In some embodiments, electrode materials described herein can include conventional electrode materials (e.g., including lithium metal).

Systems and methods for charging and discharging a plurality of batteries connected in series are described in U.S. Pat. No. 10,153,651, entitled “Systems and Methods for Series Battery Charging,” (“the '651 patent”), the disclosure of which is incorporated herein by reference in its entirety. Electrochemical cell chemistries and anode/cathode compositions are described in U.S. Pat. No. 9,437,864, entitled, “Asymmetric Battery Having a Semi-Solid Cathode and High Energy Density Anode,” (“the '864 patent”), the disclosure of which is incorporated herein by reference in its entirety.

In some embodiments, the electrodes and/or the electrochemical cells described herein can include solid-state electrolytes. In some embodiments, anodes described herein can include a solid-state electrolyte. In some embodiments, cathodes described herein can include a solid-state electrolyte. In some embodiments, electrochemical cells described herein can include solid-state electrolytes in both the anode and the cathode. In some embodiments, the electrochemical cells described herein can include unit cell structures with solid-state electrolytes. In some embodiments, the solid-state electrolyte material can be a powder mixed with the binder and then processed (e.g. extruded, cast, wet cast, blown, etc.) to form the solid-state electrolyte material sheet. In some embodiments, solid-state electrolyte material is one or more of oxide-based solid electrolyte materials including a garnet structure, a perovskite structure, a phosphate-based Lithium Super Ionic Conductor (LISICON) structure, a glass structure such as La_{0.51}Li_{0.34}TiO_{2.94}, Li_{1.3}Al_{0.3}Ti_{1.7}(PO₄)₃, Li_{1.4}Al_{0.4}Ti_{1.6}(PO₄)₃, Li₇La₃Zr₂O₁₂, Li_{6.6}6La₃Zr_{1.6}Ta_{0.4}O_{12.9} (LLZO), 50Li₄SiO₄.50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, Li₃BO₃—Li₂SO₄—Li₂CO₃ (LIBSCO, pseudoternary system), and/or sulfide contained solid electrolyte materials including a thio-LISICON structure, a glassy structure and a glass-ceramic structure such as Li_{1.07}Al_{0.69}Ti_{1.46}(PO₄)₃, Li_{1.5}Al_{0.5}Ge_{1.5}(PO₄)₃, Li₁₀GeP₂S₁₂ (LGPS), 30Li₂S.26B₂S₃.44LiI, 63Li₂S.36SiS₂.1Li₃PO₄, 57Li₂S.38SiS₂.5Li₄SiO₄, 70Li₂S.30P₂S₅, 50Li₂S.50GeS₂, Li₇P₃S₁₁, Li_{3.25}P_{0.95}S₄, and Li_{9.54}Si_{1.74}P_{1.44}S_{11.7}Cl_{0.3}, and/or closo-type complex hydride solid electrolyte such as LiBH₄—LiI, LiBH₄—LiNH₂. LiBH₄—P₂S₅, Li(CB_{X}H_{X+1})—LiI like Li(CB₉H₁₀)—LiI, and/or lithium electrolyte salt bis(trifluoromethane)sulfonamide (TFSI), bis(pentalluoroethanesulfonyl)imide (BETI), bis(fluorosulfonyl)imide, lithium borate oxalato phosphine oxide (LiBOP), lithium bis(fluorosulfonyl)imide, amide-borohydride, LiBF₄, LiPF₆ LIF, or combinations thereof. In some embodiments, electrodes described herein can include about 40 wt. % to about 90 wt % solid-state electrolyte material. Examples of electrochemical cells and electrodes that include solid-state electrolytes are described in U.S. Pat. No. 10,734,672 entitled, “Electrochemical Cells Including Selectively Permeable Membranes. Systems and Methods of Manufacturing the Same,” filed Jan. 8, 2019 (“the '672 patent”), the disclosure of which is incorporated herein by reference in its entirety.

As used in this specification and the appended claims, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the term “set” can refer to multiple features or a singular feature with multiple parts. For example, when referring to set of battery modules, the set of modules can be considered as one module with distinct portions (e.g., cell fixtures, wires, connectors, etc.), or the set of modules can be considered as multiple modules. Similarly stated, a monolithically constructed item can include a set of modules. Such a set of modules can include, for example, multiple portions that are discontinuous from each other. A set of modules can also be manufactured from multiple items that are produced separately and are later joined together (e.g., via a weld, an adhesive, or any suitable method).

As used herein, the terms “about,” “approximately,” and “substantially” when used in connection with a numerical value is intended to convey that the value so defined is nominally the value stated. Said another way, the terms about, approximately, and substantially when used in connection with a numerical value generally include the value stated plus or minus a given tolerance. For example, in some instances, a suitable tolerance can be plus or minus 10% of the value stated; thus, about 0.5 would include 0.45 and 0.55, about 10 would include 9 to 11, about 1000 would include 900 to 1100. In other instances, a suitable tolerance can be plus or minus an acceptable percentage of the last significant figure in the value stated. For example, a suitable tolerance can be plus or minus 10% of the last significant figure; thus, about 10.1 would include 10.09 and 10.11, approximately 25 would include 24.5 and 25.5. Such variance can result from manufacturing tolerances or other practical considerations (such as, for example, tolerances associated with a measuring instrument, acceptable human error, or the like).

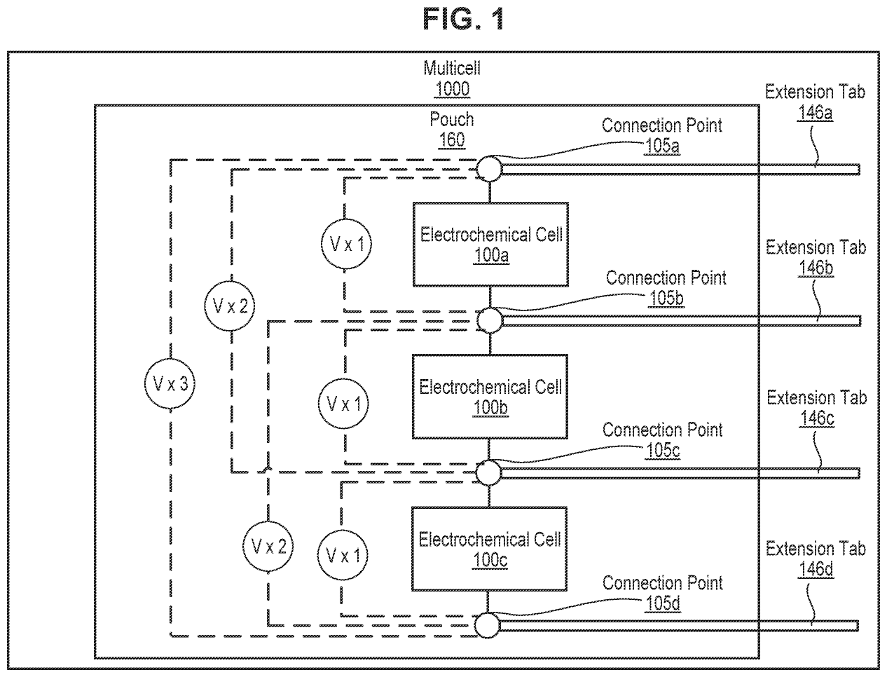

FIG. 1 shows a multicell 1000, according to an embodiment. As shown, the multicell 1000 includes electrochemical cells 100a, 100b, 100c (collectively referred to as electrochemical cells 100) and connection points 105a, 105b, 105c, 105d (collectively referred to as connection points 105). As shown, the electrochemical cells 100 are connected in series on a single circuit in a pouch 160. In some embodiments, the multicell 1000 can include extension tabs 146a, 146b, 146c. 146d (collectively referred to as extension tabs 146) that extend from the connection points 105 inside the pouch 160 to outside the pouch 160. An external circuit (not shown) can be connected to any two of the extension tabs 146 to achieve a desired voltage.

As shown, each of the electrochemical cells 100 has a voltage V. A voltage drop across one of the electrochemical cells 100 is V×1. In other words, the voltage drop from the extension tab 146a to the extension tab 146b (i.e., across electrochemical cell 100a) is V×1. As shown, the voltage drop across two of the electrochemical cells 100 (e.g., from the extension tab 146a to the extension tab 146c) is V×2. As shown, the voltage drop across three of the electrochemical cells 100 (e.g., from the extension tab 146a to the extension tab 146d) is V x 3. As shown, each of the electrochemical cells 100 has a voltage V that is substantially the same. In some embodiments, the electrochemical cells 100 can have voltages that vary. In some embodiments, the electrochemical cell 100a can have a first voltage and the electrochemical cell 100b can have a second voltage, the second voltage different from the first voltage. In some embodiments, the electrochemical cell 100c can have a third voltage, the third voltage different from the first voltage and the second voltage. As an example of varying voltage, the electrochemical cell 100a can have a voltage of 1 V and the electrochemical cell 100b can have a voltage of 0.5 V. In such a case, the voltage drop from the extension tab 146a to the extension tab 146c would be 1.5 V. In some embodiments, each of the electrochemical cells 100 can have the same cell chemistry. In some embodiments, the electrochemical cells 100 can have varying cell chemistries. In other words, the electrochemical cell 100a can have first cell chemistry and the electrochemical cell 100b can have a second cell chemistry, the second cell chemistry different from the first cell chemistry. In some embodiments, the electrochemical cell 100c can have a third cell chemistry, the third cell chemistry different from the first cell chemistry and the second cell chemistry.

As shown, the multicell 1000 includes three electrochemical cells 100. In some embodiments, the multicell 1000 can include at least about 4, at least about 5, at least about 6, at least about 7, at least about 8, at least about 9, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 electrochemical cells 100. In some embodiments, the multicell 1000 can include no more than about 100, no more than about 95, no more than about 90, no more than about 85, no more than about 80, no more than about 75, no more than about 70, no more than about 65, no more than about 60, no more than about 55, no more than about 50, no more than about 45, no more than about 40, no more than about 30, no more than about 20, no more than about 10, no more than about 9, no more than about 8, no more than about 7, no more than about 6, or no more than about 5 electrochemical cells 100. Combinations of the above-referenced ranges for the number of electrochemical cells 100 in the multicell 1000 are also possible (e.g., at least about 4 and less than about 100 or at least about 10 and less than about 20), inclusive of all values and ranges therebetween. In some embodiments, the multicell 1000 can include about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, or about 100 electrochemical cells 100.

As shown, the multicell 1000 includes four connection points 105. In some embodiments, the multicell 1000 can include at least about 5, at least about 6, at least about 7, at least about 8, at least about 9, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 connection points 105. In some embodiments, the multicell 1000 can include no more than about 100, no more than about 95, no more than about 90, no more than about 85, no more than about 80, no more than about 75, no more than about 70, no more than about 65, no more than about 60, no more than about 55, no more than about 50, no more than about 45, no more than about 40, no more than about 30, no more than about 20, no more than about 10, no more than about 9, no more than about 8, no more than about 7, or no more than about 6, connection points 105. Combinations of the above-referenced ranges for the number of connection points 105 in the multicell 1000 are also possible (e.g., at least about 5 and less than about 100 or at least about 10 and less than about 20), inclusive of all values and ranges therebetween. In some embodiments, the multicell 1000 can include about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, or about 100 connection points 105.

As shown, the multicell 1000 includes four extension tabs 146. In some embodiments, the multicell 1000 can include at least about 5, at least about 6, at least about 7, at least about 8, at least about 9, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 extension tabs 146. In some embodiments, the multicell 1000 can include no more than about 100, no more than about 95, no more than about 90, no more than about 85, no more than about 80, no more than about 75, no more than about 70, no more than about 65, no more than about 60, no more than about 55, no more than about 50, no more than about 45, no more than about 40, no more than about 30, no more than about 20, no more than about 10, no more than about 9, no more than about 8, no more than about 7, or no more than about 6 extension tabs 146. Combinations of the above-referenced ranges for the number of extension tabs 146 in the multicell 1000 are also possible (e.g., at least about 5 and less than about 100 or at least about 10 and less than about 20), inclusive of all values and ranges therebetween. In some embodiments, the multicell 1000 can include about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, or about 100 extension tabs 146.

In some embodiments, a plurality of multicells 1000 can be connected in series. In some embodiments, 2, 3, 4, 5, 6, 7, 8, 9, 10, 11, 12, 13, 14, 15, 16, 17, 18, 19, 20, or at least about 20 multicells 1000 can be connected in series, inclusive of all values and ranges therebetween. In some embodiments, a plurality of multicells 1000 can be connected in parallel. In some embodiments, 2, 3, 4, 5, 6, 7, 8, 9, 10, 11, 12, 13, 14, 15, 16, 17, 18, 19, 20, or at least about 20 multicells 1000 can be connected in parallel. In some embodiments, a plurality of multicells 1000 can be connected both in series and in parallel in an m×n configuration, wherein m is a positive integer representing the number of multicells 1000 in a single series of multicells 1000 and n is a positive integer representing the number of series of multicells 1000 connected in parallel. In some embodiments, m and/or n can be 2, 3, 4, 5, 6, 7, 8, 9, 10, 11, 12, 13, 14, 15, 16, 17, 18, 19, 20, or at least about 20, inclusive of all values and ranges therebetween

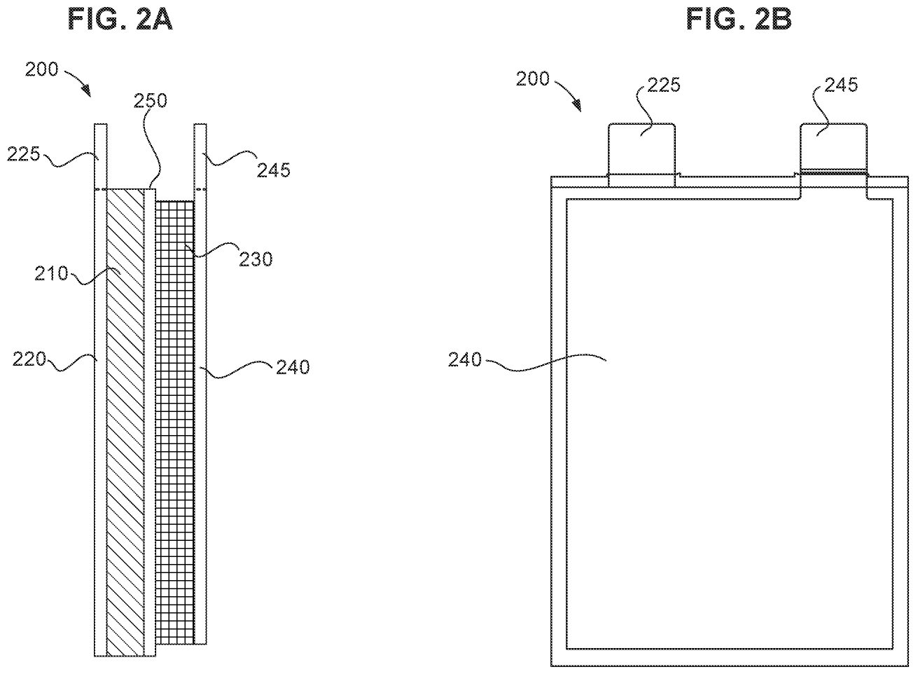

FIGS. 2A-2B show an individual electrochemical cell 200, according to an embodiment. The electrochemical cell includes an anode 210 dispose on an anode current collector 220, a cathode 230 disposed on a cathode current collector 240, and a separator 250 disposed between the anode 210 and the cathode 230. The anode current collector 220 includes an anode weld tab 225 while the cathode current collector 240 includes a cathode weld tab 245. FIG. 2A is a cross-sectional view of the individual electrochemical cell 200, while FIG. 2B is a front view of the individual electrochemical cell 200 with the cathode side in front.

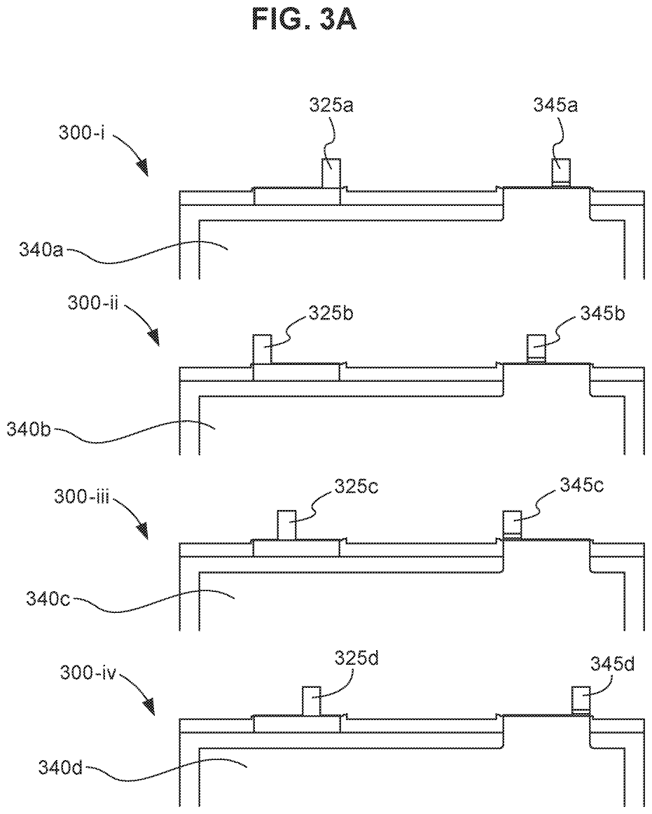

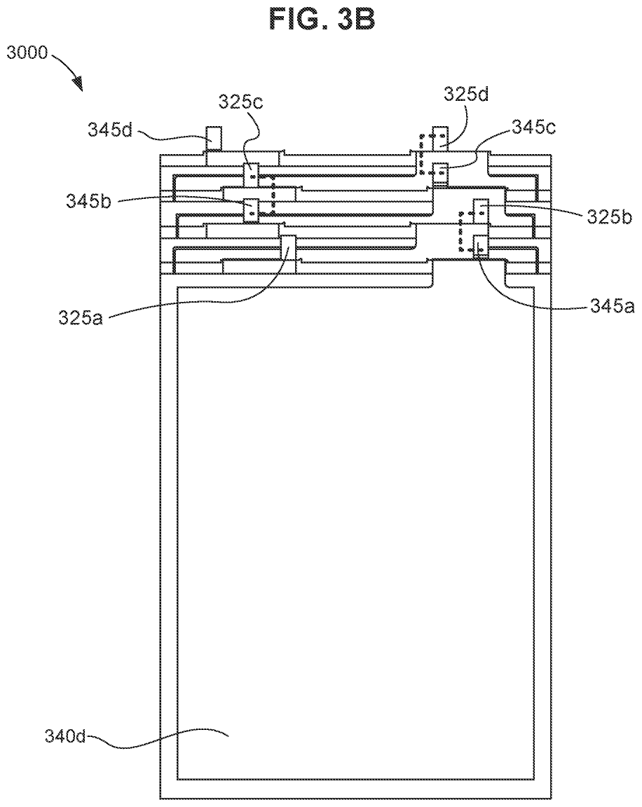

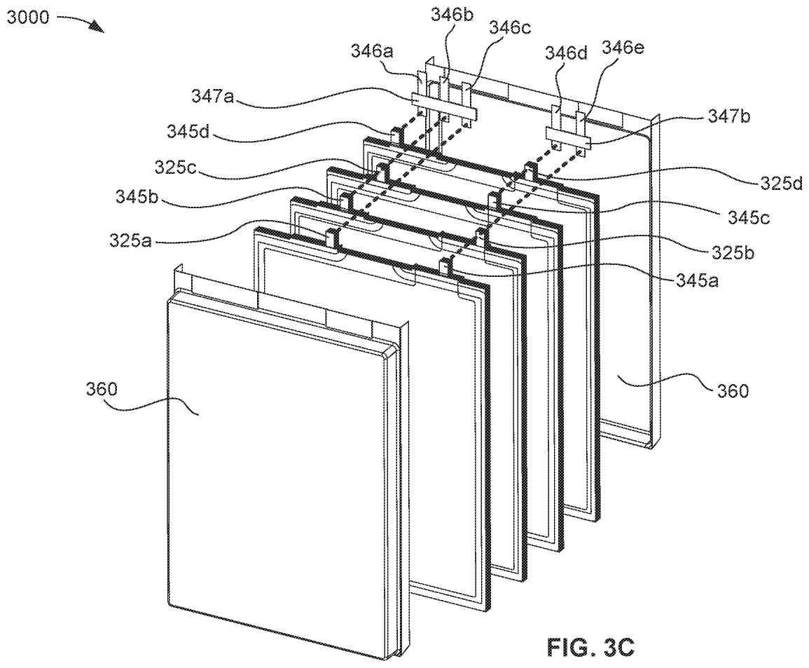

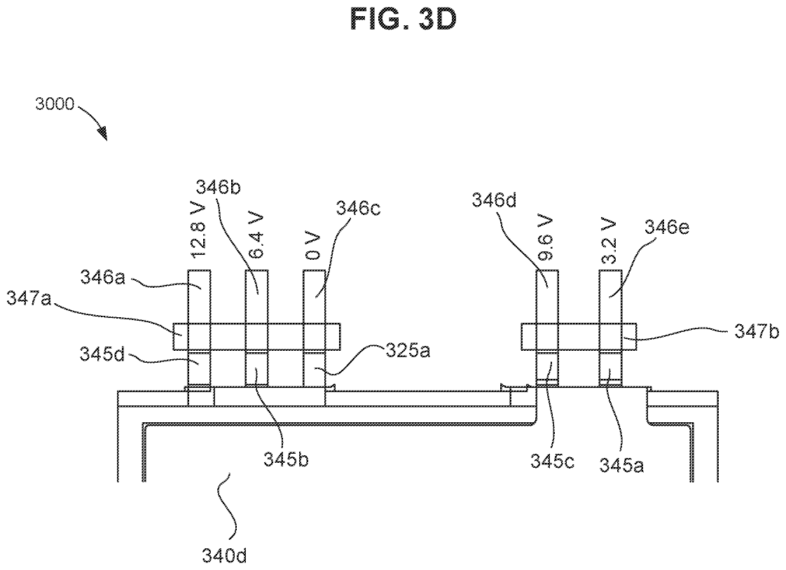

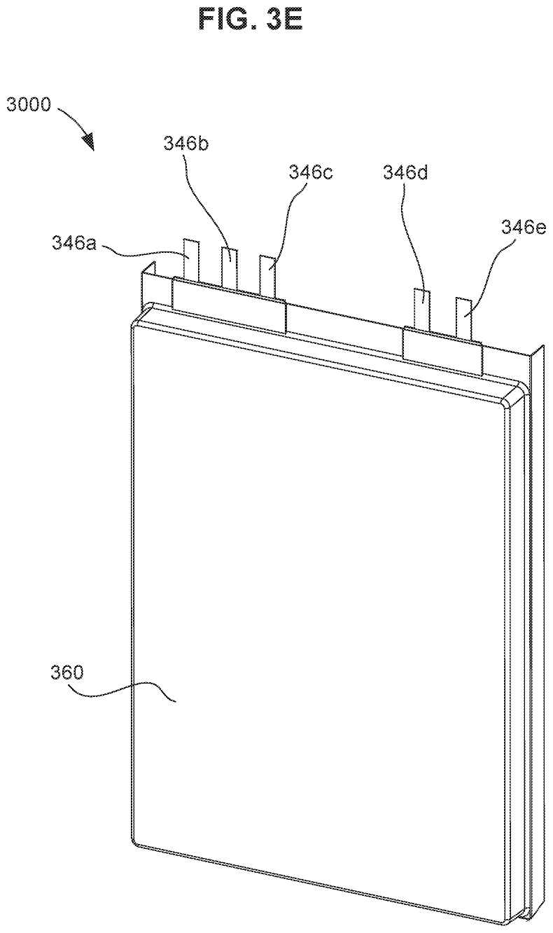

FIGS. 3A-3E show a multicell 3000 with a plurality of electrochemical cells 300-i, 300-ii, 300-iii, 300-iv (collectively referred to as electrochemical cells 300), according to an embodiment. FIG. 3A shows four electrochemical cells 300, including anode weld tabs 325a, 325b, 325c, 325d (collectively referred to as anode weld tabs 325) and cathode weld tabs 345a, 345b, 345c, 345d (collectively referred to as cathode weld tabs 345). As shown, cathode current collectors 340a. 340b, 340c, 340d (collectively referred to as cathode current collectors 340) are visible in FIG. 3A, while the anode current collectors are on the opposite side of each electrochemical cell 300, thus not shown. The electrochemical cells 300 can include each of the components described above with reference to the individual electrochemical cell 200 described above with reference to FIGS. 2A-2B.

FIG. 3B shows the electrochemical cells 300 of FIG. 3A stacked together to form the multicell 3000. As shown, each of the anode weld tabs 325 and each of the cathode weld tabs 345 have been trimmed to a prescribed shape, with dotted lines representing electrical contact between adjacent electrochemical cells 300. Trimming the anode weld tabs 325 and the cathode weld tabs 345 to prescribed shapes can aid in selectively coupling (i.e., both electronically and mechanically) these tabs while isolating these tabs from undesired electrical contact. In other words, the cathode weld tab 345a of the first electrochemical cell 300-i can be coupled to the anode weld tab 325b of the second electrochemical cell 300-ii, and if both of these tabs are trimmed such that they can only make contact with each other, this can reduce the instances of undesired electric contact between tabs (i.e., short circuiting). In other words, as shown in FIG. 3B, cathode weld tab 345a is coupled to anode weld tab 325b, cathode weld tab 345b is coupled to anode weld tab 325c, cathode weld tab 345c is coupled to anode weld tab 325d. Anode weld tab 325a and cathode weld tab 345d are left to be connected to an external circuit. In some embodiments, the couplings between anode weld tabs 325 and cathode weld tabs 345 can be done by ultrasonic welding, soldering, brazing, or any other suitable coupling technique.

FIGS. 3C and 3D show additional components of the manufacturing of the multicell 3000. The multicell 3000 includes extension tabs 346a, 346b, 346c, 346d, 346e (collectively referred to as extension tabs 346), insulating strips 347a, 347b (collectively referred to as insulating strips 347), and a pouch 360. FIG. 3C is an exploded view of the layers of the multicell 3000 with dotted lines representing electrical contact. FIG. 3D is a detailed view of connections between the extension tabs 346, the anode weld tabs 325, and the cathode weld tabs 345. As shown, extension tab 346a is coupled to cathode weld tab 345d, extension tab 346b is coupled to anode weld tab 325c and cathode weld tab 345b, extension tab 346c is coupled to anode weld tab 325a, extension tab 346d is coupled to anode weld tab 325d and cathode weld tab 345c, and extension tab 346e is coupled to anode weld tab 325b and cathode weld tab 345a. In some embodiments, couplings between the extension tabs 346, the anode weld tabs 325, and the cathode weld tabs 345 can be done by ultrasonic welding, soldering, brazing, or any other suitable coupling technique. In some embodiments, insulating strips 347 can be coupled to the extension tabs 346.

In some embodiments, the insulating strips 347 can keep the extension tabs 346 from moving independently and being bent in undesired directions. In some embodiments, the insulating strips 347 can help prevent undesired electrical contact between any of the extension tabs 346, the anode weld tabs 325, or the cathode weld tabs 345. In some embodiments, the insulating strips 347 can include an adhesive surface, such that the extension tabs 346 are secured to an interior surface of the pouch 360. The extension tabs 346 can extend to the exterior of the pouch 360 and can serve as connection points for connector wires. FIG. 3D shows sample voltages associated with each of the extension tabs 346 as a means of example. If each of the electrochemical cells 300 is a lithium iron phosphate (LFP) cell, then the cell voltage of each of the electrochemical cells 300 is approximately 3.2 V, when in a fully charged state. Therefore, a custom voltage can be selected for a given application, based on the placement of connector wires. For example, if a first connector wire (not shown) is connected to extension tab 346c and a second connector wire (not shown) is connected to extension tab 346a, the total voltage drop from the first connector wire to the second connector wire would be about 12.8 V. In this configuration and example, any other multiple of 3.2 V is possible. For example, if the first connector wire is connected to extension tab 346c and the second connector wire is connected to extension tab 346e, the total voltage drop from the first connector wire to the second connector wire would be about 3.2 V.

FIG. 3E shows the multicell 3000, in a fully constructed state. As shown, the extension tabs 346 all extend to the exterior of the pouch 360. As shown and described in FIGS. 3A-3E, the multicell 3000 includes four electrochemical cells 300. In some embodiments, the multicell 3000 can include two, three, five, six, seven, eight, nine, ten, or more electrochemical cells 300. In some embodiments, a plurality of multicells 3000 can be stacked together to create an electrochemical cell system. As shown, the multicell 3000 is housed in a pouch. In some embodiments, the multicell 3000 can be housed in a hard-cased can, or any other suitable electrochemical cell containment means.

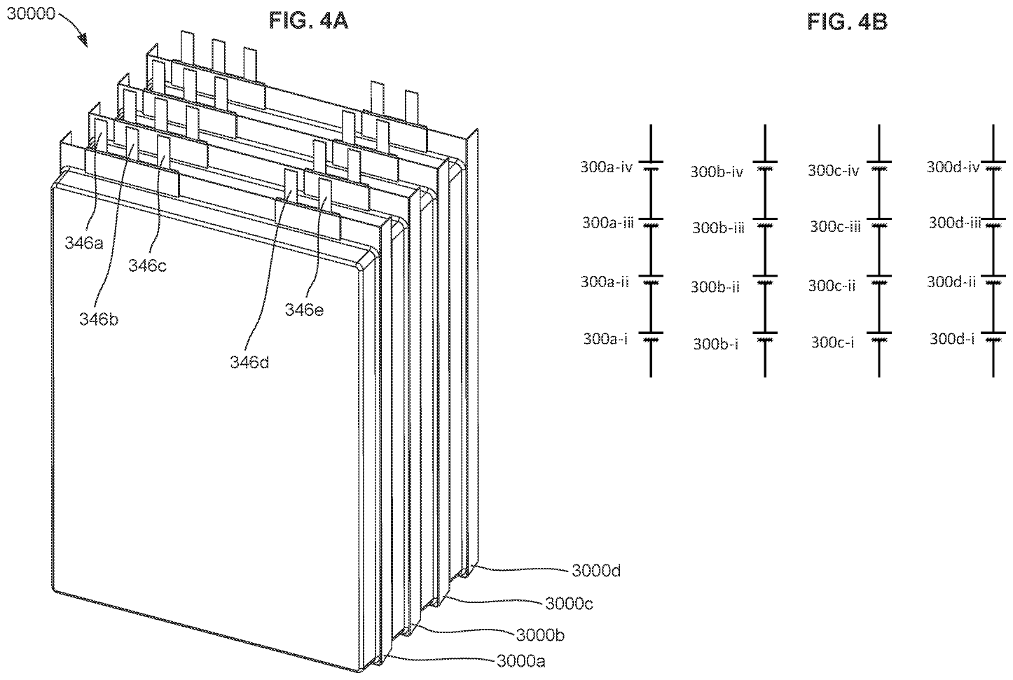

FIGS. 4A-7B show various physical and electrical connection schemes for joining multicells 3000a, 3000b, 3000c, 3000d (collectively referred to as multicells 3000), according to various embodiments. Multicell 3000a includes electrochemical cells 300a-i, 300a-ii, 300a-iii, 300a-iv (collectively referred to as electrochemical cells 300a) connected in series. Multicell 3000b includes electrochemical cells 300b-i, 300b-ii, 300b-iii, 300b-iv (collectively referred to as electrochemical cells 300b) connected in series. Multicell 3000c includes electrochemical cells 300c-i, 300c-ii, 300c-iii, 300c-iv (collectively referred to as electrochemical cells 300c) connected in series. Multicell 3000d includes electrochemical cells 300d-i, 300d-ii, 300d-iii, 300d-iv (collectively referred to as electrochemical cells 300d) connected in series. Each of the multicells 3000 includes extension tabs 346a. 346b, 346c, 346d, 346e (collectively referred to as extension tabs 346).

FIGS. 4A-4B show a multicell system 30000, the multicell system 30000 including multicells 3000 that are physically coupled to each other but electrically isolated from one another. FIG. 4A is a physical depiction of the multicell system 30000 while FIG. 4B is a circuit diagram of the multicell system 30000. As shown, electrochemical cells 300a are operable in a single series, electrochemical cells 300b are operable in a single series, electrochemical cells 300c are operable in a single series, and electrochemical cells 300d are operable in a single series. In other words, no electrical connection exists between electrochemical cells 300a, electrochemical cells 300b, electrochemical cells 300c, or electrochemical cells 300d. As shown, the multicell system 30000 includes four multicells 3000. In some embodiments, the multicell system 30000 can include 2, 3, 5, 6, 7, 8, 9, 10, 11, 12, 13, 14, 15, 16, 17, 18, 19, 20, or more than about 20 multicells 3000, inclusive of all values and ranges therebetween.

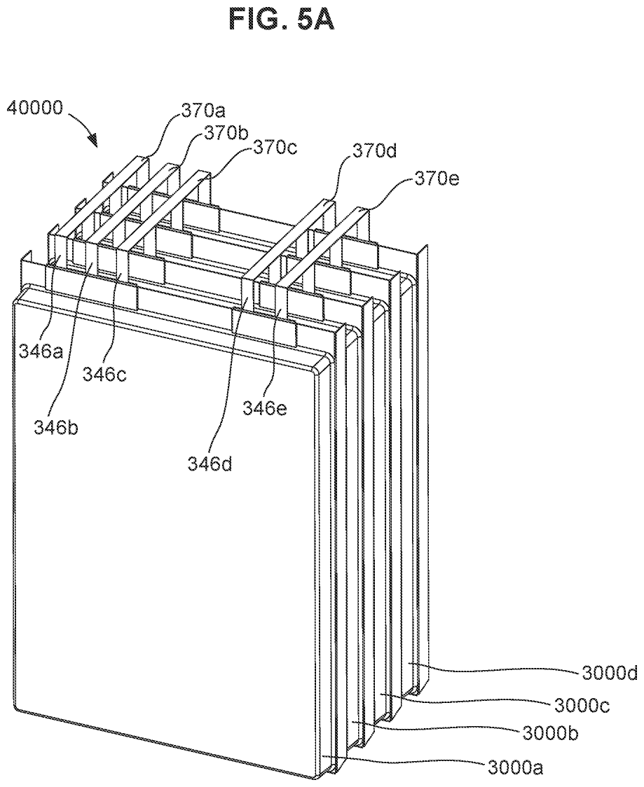

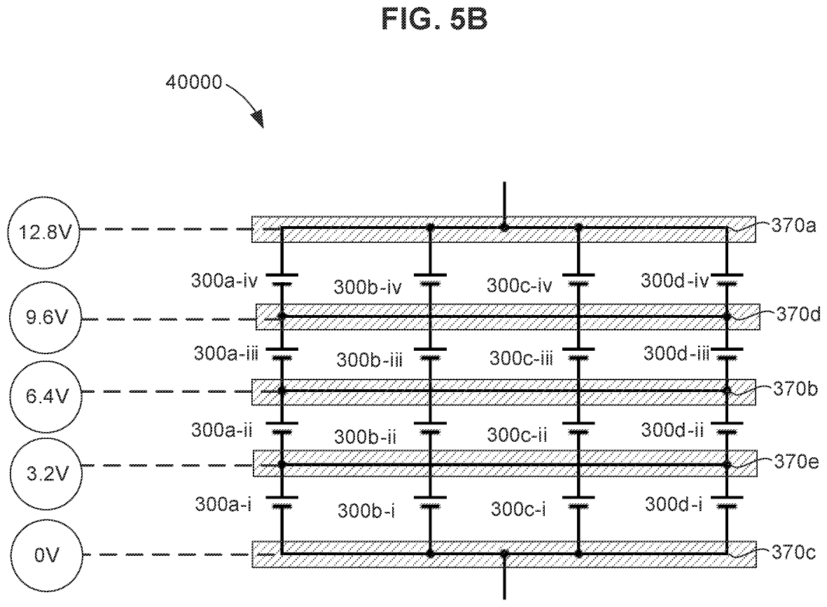

FIGS. 5A-5B show a multicell system 40000 that includes a plurality of multicells 3000 connected in parallel, according to an embodiment. FIG. 5A is a physical depiction of the multicell system 40000 while FIG. 5B is a circuit diagram of the multicell system 40000. The multicell system 40000 includes full parallel connectors 370a, 370b, 370c, 370d, 370e (collectively referred to as full parallel connectors 370) that electrically connect the extension tabs 346 across all of the multicells 3000. In other words, each of the full parallel connectors 370 connects all of the extension tabs 346 with the same reduction potential. Reduction potentials are shown in the circuit diagram of FIG. 5B, by way of example. As shown, electrochemical cell 300a-i is connected in parallel with electrochemical cells 300b-i, 300c-i, and 300d-i, electrochemical cell 300a-ii is connected in parallel with electrochemical cells 300b-ii, 300c-ii, and 300d-ii, electrochemical cell 300a-iii is connected in parallel with electrochemical cells 300b-iii, 300c-iii, and 300d-iii, electrochemical cell 300a-iv is connected in parallel with electrochemical cells 300b-iv, 300c-iv, and 300d-iv. The multicell system 40000 has the same reduction potentials at full parallel connectors 370a, 370b, 370c, 370d, 370d, 370e as the multicell 3000a, 3000b, 3000c, or 3000d has at extension tabs 346a, 346b, 346c, 346d, and 346e, respectively. However, the multicell system 40000 has an energy capacity that is four times the energy capacity of the multicell 3000a, 3000b, 3000c, or 3000d. As shown, the multicell system 40000 includes four multicells 3000 and four full parallel connectors 370. In some embodiments, the multicell system 30000 can include 2, 3, 5, 6, 7, 8, 9, 10, 11, 12, 13, 14, 15, 16, 17, 18, 19, 20, or more than about 20 multicells 3000 and full parallel connectors 370, inclusive of all values and ranges therebetween.

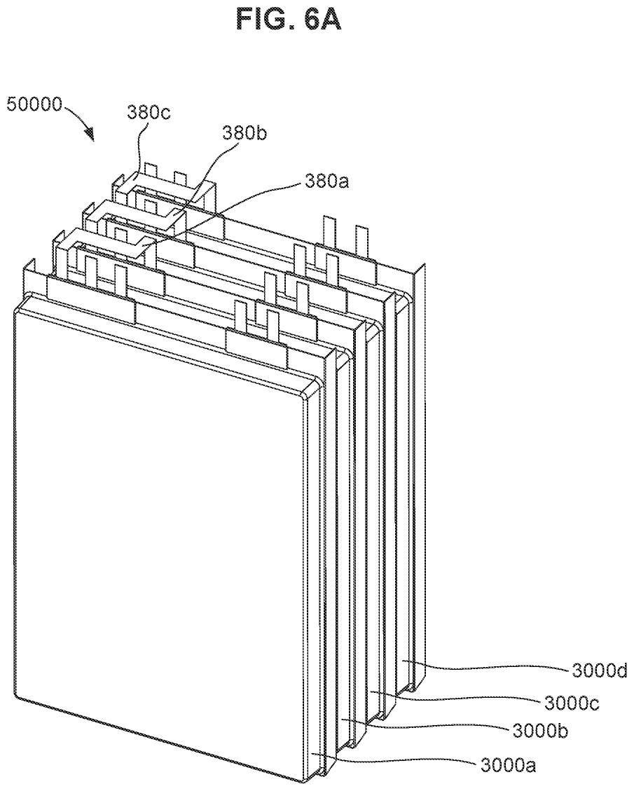

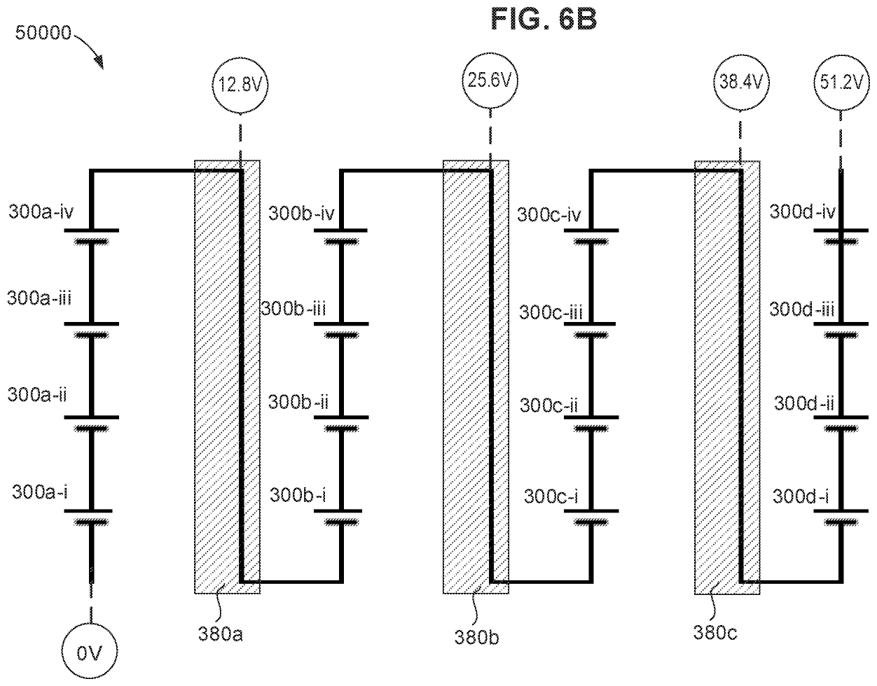

FIGS. 6A-6B show a multicell system 50000 that includes a plurality of multicells 3000 connected in series, according to an embodiment. FIG. 6A is a physical depiction of the multicell system 50000 while FIG. 6B is a circuit diagram of the multicell system 50000. The multicell system 50000 includes series connectors 380a, 380b, 380c (collectively referred to as series connectors 380). As shown, the series connector 380a connects the extension tab with the highest reduction potential (346a) from the multicell 3000a to the extension tab with the lowest reduction potential (346c) the multicell 3000b. As shown, the series connector 380b connects the extension tab with the highest reduction potential (346a) from the multicell 3000b to the extension tab with the lowest reduction potential (346c) the multicell 3000c. As shown, the series connector 380c connects the extension tab with the highest reduction potential (346a) from the multicell 3000c to the extension tab with the lowest reduction potential (346c) the multicell 3000d. Reduction potentials are shown in the circuit diagram of FIG. 6B, by way of example. As shown, the voltage drop across the multicell system 50000 is 16 times the voltage drop across a single electrochemical cell (e.g., 300a-i), while the energy capacity of the multicell system 50000 is the same as the energy capacity of a single electrochemical cell. As shown, the multicell system 50000 includes four multicells 3000 connected in series. In some embodiments, the multicell system 50000 can include 2, 3, 5, 6, 7, 8, 9, 10, 11, 12, 13, 14, 15, 16, 17, 18, 19, 20, or more than about 20 multicells 3000, inclusive of all values and ranges therebetween. As shown, the multicell system 50000 includes three series connectors 380. In some embodiments, the multicell system 50000 can include 2, 4, 5, 6, 7, 8, 9, 10, 11, 12, 13, 14, 15, 16, 17, 18, 19, 20, or more than about 20 series connectors 380, inclusive of all values and ranges therebetween.

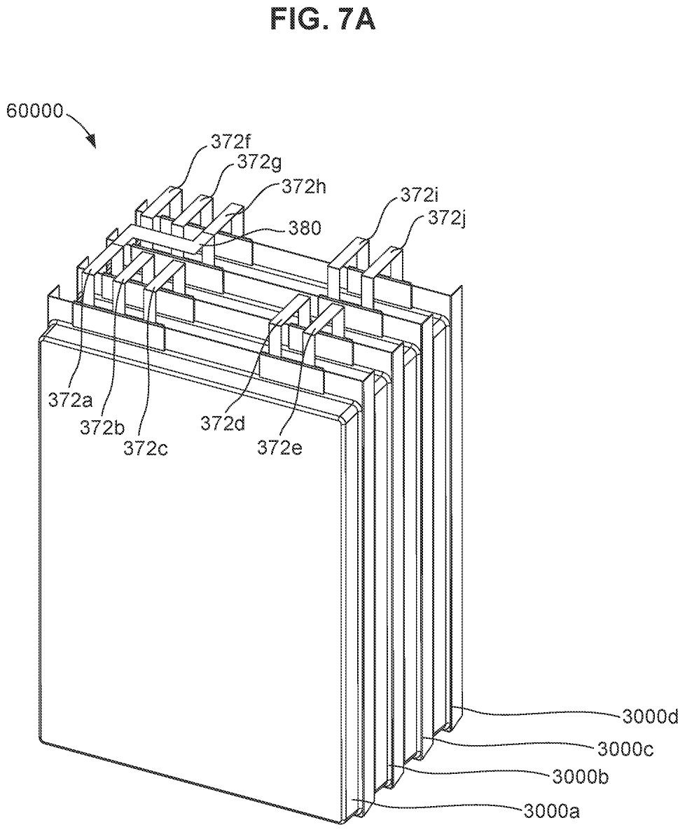

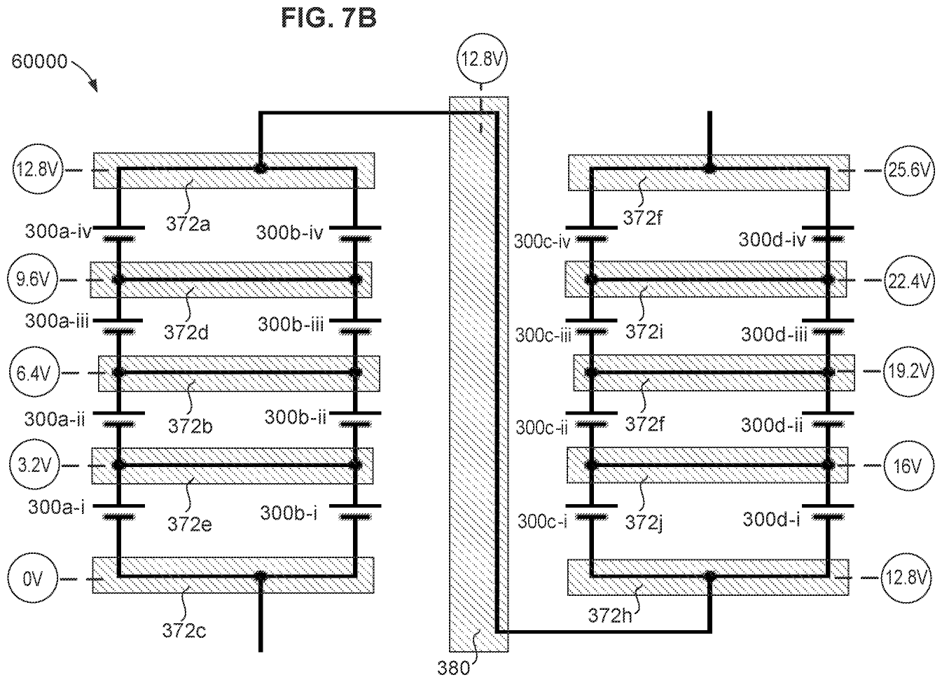

FIGS. 7A-7B show a multicell system 60000 that includes a plurality of multicells 3000 connected both in series and in parallel, according to an embodiment. FIG. 7A is a physical depiction of the multicell system 60000 while FIG. 7B is a circuit diagram of the multicell system 60000. The multicell system 60000 includes partial parallel connectors 372a, 372b, 372c, 372d, 372e, 372f, 372g, 372h, 372i, 372j (collectively referred to as partial parallel connectors 372) and series connector 380. As shown, the partial parallel connectors 372 connect extension tabs 346 between multicell 3000a and multicell 3000b as well as extension tabs 346 between multicell 3000c and multicell 3000d. The series connector 380 connects multicells 3000a, 3000b to multicells 3000c, 3000d in series. Reduction potentials are shown in the circuit diagram of FIG. 7B, by way of example. As shown, the voltage drop across the multicell system 60000 is 8 times the voltage drop across a single electrochemical cell (e.g., 300a-i), while the energy capacity of the multicell system 60000 is the double the energy capacity of a single electrochemical cell. As shown, the multicell system 60000 includes two series of multicells 3000 connected in parallel, each series of multicells 3000 including two multicells 3000. In some embodiments, the multicell system 60000 can include m series of multicells 3000 connected in parallel, each series of multicells 3000 including n multicells 3000, wherein m and/or n are 3, 4, 5, 6, 7, 8, 9, 10, 11, 12, 13, 14, 15, 16, 17, 18, 19, 20, or at least about 20, inclusive of all values and ranges therebetween.

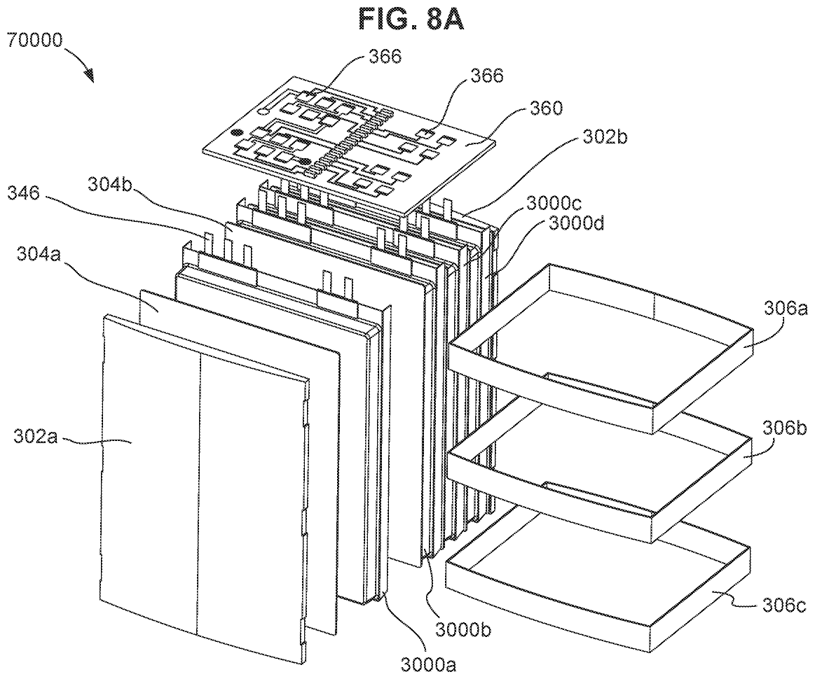

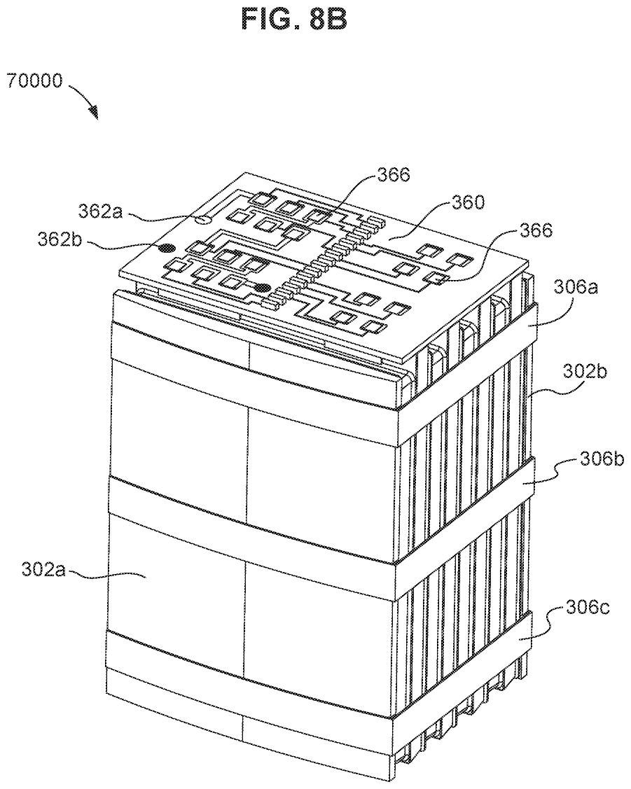

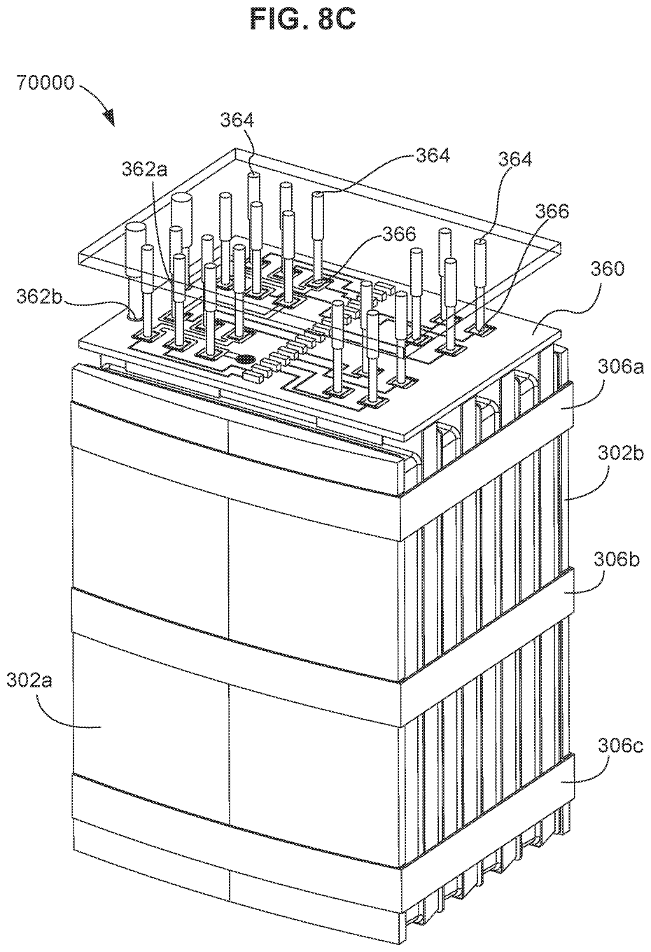

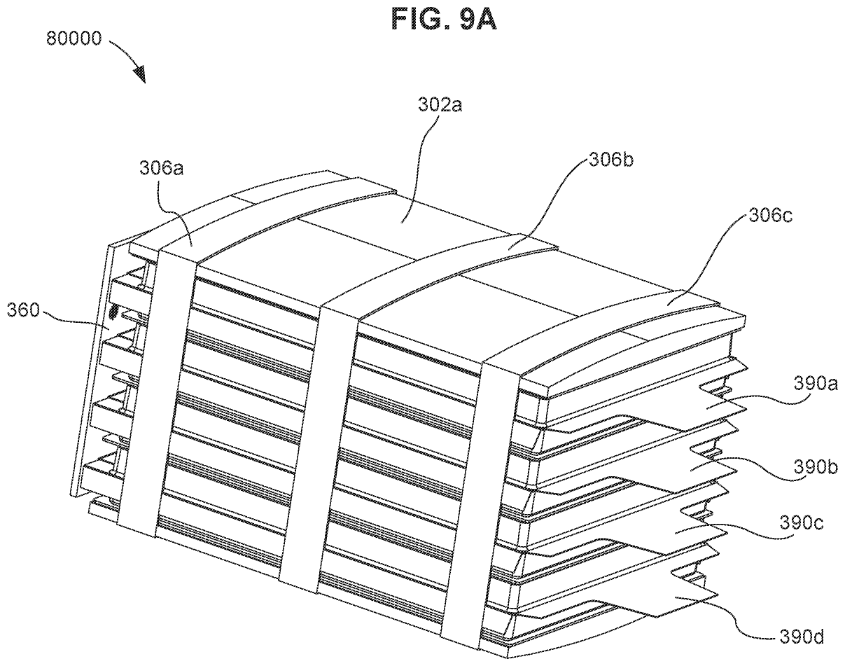

FIGS. 8A-8C show a multicell system 70000 that includes a plurality of multicells 3000a, 3000b, 3000c, 3000d (collectively referred to as multicells 3000), according to an embodiment. As shown in FIGS. 8A-8C, the multicell system 70000 includes multicells 3000 (each of which includes extension tabs 346), end plates 302a, 302b (collectively referred to as end plates 302), spacers 304a, 304b (collectively referred to as spacers 304), restraining straps 306a. 306b, 306c (collectively referred to as restraining straps 306), and BMS circuit board 360. In some embodiments, the BMS circuit board 360 can include main power connections 362a, 362b (collectively referred to as main power connections 362) and contact pads 366. Multicell tabs 346 may be electrically connected to contact pads 366 by ultrasonic welding, soldering, brazing, or any other suitable coupling technique. In some embodiments, the end plates 302 and the restraining straps 306 can be used to provide compression and structural cohesion to the multicells 3000. In some embodiments, the spacers 304 can minimize physical contact between the multicells 3000. In some embodiments, the spacers 304 can be composed of a soft, insulating material, such that damage of the multicells 3000 is minimized while the multicells 3000 are compressed together.

In some embodiments, a BMS circuit board 360 can control charge and discharge within specified limits. This can be useful during a formation cycle period of the electrochemical cell system 30000. By controlling the charge and discharge within specified limits during formation cycles, the evolution of various electrochemical species can be more precisely controlled and monitored. This can allow for the simple removal and replacement of a multicell 3000 if the multicell 3000 fails quality control protocol during formation cycling. In other words, a small portion of the multicell system 70000 can be selectively and precisely replaced, rather than replacing the entire multicell system 70000 or individually testing each component of the multicell system 70000 to find the faulty component.

Voltage can be monitored for quality control by the use of main power connections 362 and pogo pins 364. During testing, the main power connections 362 can be used to supply current to the multicell system 700M) while voltage monitoring is done via the pogo pins 364. In other words, the pogo pins 364 can be part of an external quality control monitoring system. In some embodiments, the external quality control system can monitor voltages without supplying and controlling current. Current moves through a prescribed path on the BMS circuit board 360. The pogo pins 364 can be mounted over the BMS circuit board 36) and force contact between the extension tabs 346 and the contact pads 366 before the extension tabs 346 are permanently connected to the contact pads 366. This level of current control can greatly reduce the number of current channels needed to test a multicell system. As shown, the multicell system 70000 includes four multicells 3000, and each multicell 3000 includes four electrochemical cells 300. Testing a multicell system with 16 electrochemical cells would typically require 16 current supply channels. With the aforementioned BMS circuit board 360 in place, effective testing can be achieved with one current supply channel. During testing, the BMS circuit board 360 can provide charge control (i.e., safety monitoring and cell balancing at top of charge). Since the extension tabs 346 are not yet hard-connected to the contact pads 366 on the BMS circuit board 360, a rework can be performed if a cell replacement is desired. This concept is applicable to any electrochemical cell type. As shown, the multicell system 70000 includes four multicells 3000. In some embodiments, the multicell system 70000 can include two, three, five, six, seven, eight, nine, ten, or more electrochemical cell stacks.

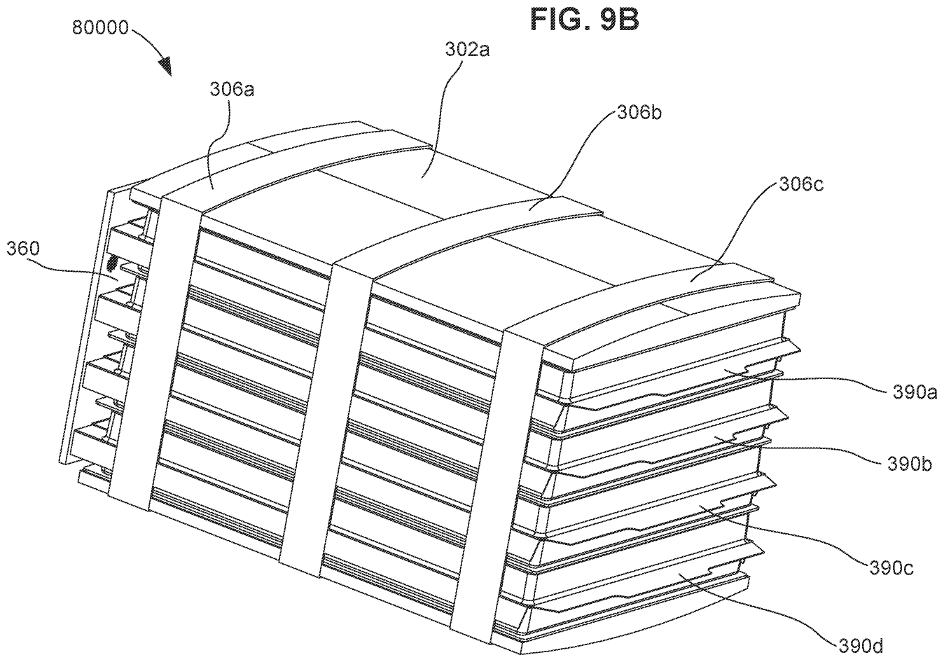

FIGS. 9A and 9B, show a multicell system 80000 that includes degassing tabs 390a, 390b, 390c, 390d (collectively referred to as degassing tabs 390). When electrochemical cells 300 and multicells 3000 are formed, they often produce a small quantity of gas, depending on the cell chemistry. Removal of this gas prior to installation of the multicell system 80000 is an important safety measure. Removal of gas from cell pouches is often performed by trimming away a portion of a heat seal on the pouch, drawing a vacuum, and then re-sealing the pouch. By locating the degassing tabs 390 away from contact points between the multicells 3000 and away from the restraining straps 306, degassing of the multicell system 80000 can be performed in-situ in a single operation. Furthermore, the restraining straps 306 and the end plates 302 can apply a clamping pressure. With the application of a clamping pressure, the use of a vacuum can be reduced, or completely eliminated. This reduction in process steps can significantly reduce the cost of production of the multicell system 80000.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java. C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion. i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A multicell, comprising:
a plurality of electrochemical cells, each of the plurality of electrochemical cells comprising:
an anode disposed on an anode current collector, the anode current collector including an anode tab;
a cathode disposed on a cathode current collector, the cathode current collector including a cathode tab; and
a separator disposed between the anode and the cathode,
wherein:
the cathode tab of a first electrochemical cell of the plurality of electrochemical cells is connected to the anode tab of a second electrochemical cell of the plurality of electrochemical cells at a first connection point;
the cathode tab of a second electrochemical cell of the plurality of electrochemical cells is connected to the anode tab of a third electrochemical cell of the plurality of electrochemical cells at a second connection point; and
wherein the plurality of electrochemical cells are disposed in a single pouch.

2. The multicell of claim 1, wherein the cathode tab of the first electrochemical cell and the anode tab of the second electrochemical cell are trimmed, such that the cathode tab of the first electrochemical cell is in physical contact with the anode tab of the second electrochemical cell and the cathode tab of the first electrochemical cell is not in physical contact with any other tabs,
and wherein the cathode tab of the second electrochemical cell and the anode tab of the third electrochemical cell are trimmed, such that the cathode tab of the second electrochemical cell is in physical contact with the anode tab of the third electrochemical cell and the cathode tab of the first electrochemical cell is not in physical contact with any other tabs.

3. The multicell of claim 1, further comprising:
a first extension tab connected to the first connection point, the first extension tab extending outside the single pouch; and
a second extension tab connected to the second connection point, the second extension tab extending outside the single pouch.

4. The multicell of claim 1, further comprising:
a fourth electrochemical cell, the fourth electrochemical cell comprising:
an anode disposed on an anode current collector, the anode current collector including an anode tab;
a cathode disposed on a cathode current collector, the cathode current collector including a cathode tab; and
a separator disposed between the anode and the cathode, wherein:
the cathode tab of a third electrochemical cell of the plurality of electrochemical cells is connected to the anode tab of a fourth electrochemical cell of the plurality of electrochemical cells at a third connection point.

5. The multicell of claim 4, further comprising:
an extension tab connected to the third connection point, the third extension tab extending outside the single pouch.

6. A multicell system, comprising:
a plurality of multicells, each of the multicells being the multicell of claim 1, wherein each of the multicells are physically connected to each other.

7. The multicell system of claim 6, wherein the plurality of multicells are connected in parallel.

8. The multicell system of claim 6, wherein the plurality of multicells are connected in series.

9. The multicell system of claim 6, wherein the plurality of multicells are connected both in series and in parallel.

10. The multicell system of claim 6, further comprising:
a battery management system configured to monitor the state of charge of each electrochemical cells of the plurality of electrochemical cells.

11. The multicell system of claim 6, wherein each multicell includes a degassing tab, each degassing tab configured to release gas from each multicell when cut.

12. A multicell, comprising:
a plurality of electrochemical cells connected in series, each of the plurality of electrochemical cells comprising:
an anode disposed on an anode current collector, the anode current collector including an anode tab;
a cathode disposed on a cathode current collector, the cathode current collector including a cathode tab, and
a separator disposed between the anode and the cathode,
wherein the cathode tab of a first electrochemical cell of the plurality of electrochemical cells physically contacts the anode tab of a second electrochemical cell of the plurality of electrochemical cells and the cathode tab of a first electrochemical cell does not contact any other tabs,
and wherein the cathode tab of a second electrochemical cell of the plurality of electrochemical cells physically contacts the anode tab of a third electrochemical cell of the plurality of electrochemical cells and the cathode tab of a second electrochemical cell does not contact any other tabs.

13. The multicell of claim 12, wherein the plurality of electrochemical cells are disposed in a single pouch.

14. The multicell of claim 12, further comprising:
a first extension tab coupled to the cathode tab of the first electrochemical cell and the anode tab of a second electrochemical cell; and
a second extension tab connected to the cathode weld tab of the second electrochemical cell and the anode weld tab of a third electrochemical cell.

15. The multicell of claim 12, further comprising:
a fourth electrochemical cell, the fourth electrochemical cell comprising:
an anode disposed on an anode current collector, the anode current collector including an anode tab;
a cathode disposed on a cathode current collector, the cathode current collector including a cathode tab; and
a separator disposed between the anode and the cathode, wherein:
the cathode tab of a third electrochemical cell of the plurality of electrochemical cells is connected to the anode tab of a fourth electrochemical cell of the plurality of electrochemical cells and the cathode tab of a third electrochemical cell does not contact any other tabs.

16. The multicell of claim 15, further comprising:
an extension tab connected to the cathode tab of the third electrochemical cell and the anode tab of the fourth electrochemical cell.

17. A multicell system, comprising:
a plurality of multicells, each multicell comprising a plurality of electrochemical cells connected in series, each multicell including a terminal anode tab and a terminal cathode tab, wherein a terminal cathode tab of a first multicell of the plurality of multicells is electrically coupled to either a terminal anode tab or a terminal cathode tab of a second multicell of the plurality of multicells.

18. The multicell system of claim 17, wherein the terminal cathode tab of the first multicell of the plurality of multicells is electrically coupled to the terminal cathode tab of the second multicell of the plurality of multicells.

19. The multicell system of claim 17, wherein the terminal cathode tab of the first multicell of the plurality of multicells is electrically coupled to the terminal anode tab of the second multicell of the plurality of multicells.

20. The multicell system of claim 18, wherein a terminal cathode tab of the second multicell of the plurality of multicells is electrically coupled to a terminal cathode tab of a third multicell of the plurality of multicells.

21. The multicell system of claim 20, wherein a terminal cathode tab of the second multicell of the plurality of multicells is electrically coupled to a terminal anode tab of a third multicell of the plurality of multicells.

22. The multicell system of claim 17, further comprising a battery management system configured to control charge and discharge of the plurality of multicells within specified limits.

23. The multicell system of claim 17, wherein each multicell of the plurality of multicells is disposed in a single pouch.
